(19) United States
(12) Patent Application Publication
(10) Pub. No.: US 2020/0149496 A1
(43) Pub. Date: May 14, 2020

(54) ROTATING DETONATION COMBUSTOR WITH CONTOURED INLET

(71) Applicant: General Electric Company, Schenectady, NY (US)

(72) Inventors: Kapil Kumar Singh, Rexford, NY (US); Narendra Digamber Joshi, Schenectady, NY (US)

(73) Assignee: General Electric Company, Schenectady, NY (US)

(21) Appl. No.: 16/185,235

(22) Filed: Nov. 9, 2018

(51) Int. Cl. F02K 9/66; F02K 9/52

(52) U.S. Cl. CPC F02K 9/66; F23R 7/00; F02K 9/52

(57) ABSTRACT

A combustion system includes an annular tube disposed between an inner wall and an outer wall, the annular tube extending from an inlet end to an outlet end; at least one fluid inlet disposed in the annular tube proximate the inlet end, the fluid inlet providing a conduit through which fluid flows into the annular tube; at least one outlet disposed in the annular tube proximate the outlet end; and at least one inlet fluid plenum disposed upstream of the fluid inlet. The inlet fluid plenum includes at least one reflective surface.

### BACKGROUND

The present subject matter relates generally to a combustor of an engine, such as a rotating detonation engine.

A rotating detonation engine includes an annulus with an inlet end through which a fuel and air mixture enters and an outlet end from which exhaust exits. A detonation wave travels in a circumferential direction of the annulus and consumes the incoming fuel and air mixture. The burned fuel and air mixture (e.g., combustion gases) exits the annulus and is exhausted with the exhaust flow.

The detonation wave provides a high-pressure region in an expansion region of the combustion system. Rotating detonation pressure gain combustion systems are expected to operate at much higher frequencies than other pressure gain combustion concepts such as pulse detonation combustors.

Maintaining a rotating detonation wave within rotating detonation combustors during low power conditions of the engines, as well as selectively controlling and/or adjusting the operating conditions present technical challenges. For example, when a rotating detonation engine is operating at an idle condition (e.g., not generating enough propulsive force to propel the engine or a vehicle that includes the engine), the detonations rotating within the combustor of the engine may dissipate or be extinguished.

### BRIEF DESCRIPTION OF THE EMBODIMENTS

Aspects of the present embodiments are summarized below. These embodiments are not intended to limit the scope of the present claimed embodiments, but rather, these embodiments are intended only to provide a brief summary of possible forms of the embodiments. Furthermore, the embodiments may encompass a variety of forms that may be similar to or different from the embodiments set forth below, commensurate with the scope of the claims.

In one aspect, a combustion system includes an annular tube disposed between an inner wall and an outer wall, the annular tube extending from an inlet end to an outlet end; at least one fluid inlet disposed in the annular tube proximate the inlet end, the fluid inlet providing a conduit through which fluid flows into the annular tube; at least one outlet disposed in the annular tube proximate the outlet end; and at least one inlet fluid plenum disposed upstream of the fluid inlet. The inlet fluid plenum includes at least one reflective surface.

In another aspect, a combustion system includes an annular tube disposed between an inner wall and an outer wall; a diverging section disposed axially forward of the annular tube, the diverging section comprising an inner diverging wall and an outer diverging wall; at least one throat area disposed axially forward of the diverging section; and a fluid inlet plenum disposed axially forward of the throat area, the fluid inlet plenum including at least one reflective surface.

In another aspect, a combustion system includes an annular tube disposed between an inner wall and an outer wall; at least one throat area disposed axially forward of the annular tube; and a fluid inlet plenum disposed axially forward of the throat area, the fluid inlet plenum including at least one reflective surface, wherein at least one rotating detonation wave travels from the reflective surface through the throat area.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective schematic representation of a rotating detonation combustor; and

FIG. 2 is a side schematic representation of a rotating detonation combustor; according to aspects of the present embodiments.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “axial” refers to a direction aligned with a central axis or shaft of a gas turbine engine or alternatively the central axis of a propulsion engine, a combustor, and/or internal combustion engine. An axially forward end of the gas turbine engine or combustor is the end proximate the fan, compressor inlet, and/or air inlet where air enters the gas turbine engine and/or the combustor. An axially aft end of the gas turbine engine or combustor is the end of the gas turbine or combustor proximate to the engine or combustor exhaust where combustion gases exit the engine or combustor. In non-turbine engines, axially aft is toward the exhaust and axially forward is toward the inlet.

As used herein, the term “circumferential” refers to a direction or directions around (and tangential to) the circumference of an annulus of a combustor, or for example the circle defined by the swept area of the turbine blades. As used herein, the terms “circumferential” and “tangential” are synonymous.

As used herein, the term “radial” refers to a direction moving outwardly away from the central axis of the gas turbine, or alternatively the central axis of a propulsion engine. A “radially inward” direction is aligned toward the central axis moving toward decreasing radii. A “radially outward” direction is aligned away from the central axis moving toward increasing radii.

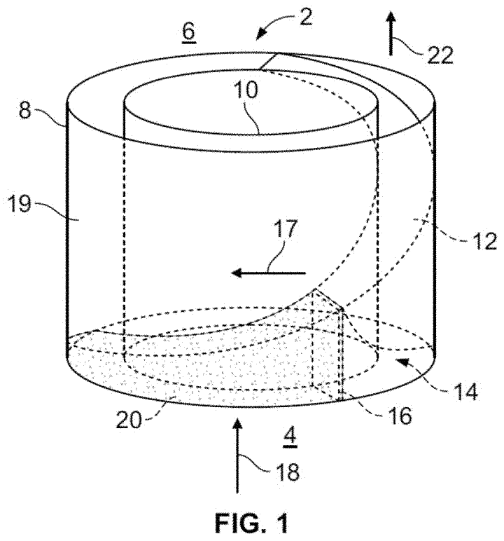

FIG. 1 illustrates a schematic diagram of one example of a rotating detonation combustor 2. The combustor 2 includes an annular combustor formed from an outer wall 8 and an inner wall 10. The combustor that is defined by the walls 8, 10 has an inlet end 4 (in which a fuel/air mixture 18 enters) and an outlet end 6 from which an exhaust flow 22 exits the combustor 2. A detonation wave 16 travels in a circumferential direction 17 of the annulus (and around an annular axis of the annulus), thereby consuming the incoming fuel/air mixture 18 and providing a high-pressure region 14 in an expansion region 12 of the combustor 2. The burned fuel/air mixture (e.g., combustion gases) 19 exit the annulus and are exhausted as the exhaust flow 22. The region 20 behind the detonation wave 16 has very high pressures and this pressure can feed back into an upstream chamber from which the air and fuel are introduced and form an unburnt fuel/air mixture 18. Thermally managing the temperatures and thermal gradients within and around the combustor 2 may enhance the durability, operability, and/or overall performance of the combustor 2.

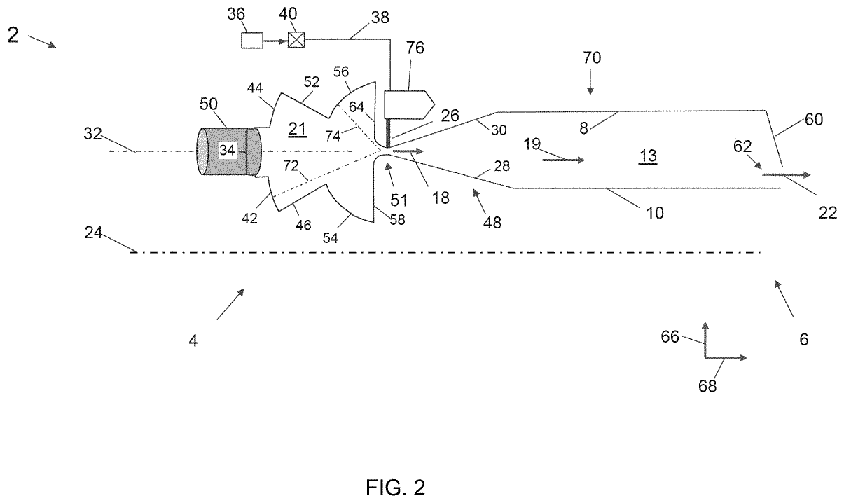

FIG. 2 illustrates a side view of a rotating detonation combustor 2 according to the embodiments disclosed herein. The combustor 2 includes a combustion tube (or annular tube) 70 extending between an inlet end 4 and an outlet end 6. The inlet end 4 includes a diverging section 48 axially forward of the annular tube 70, while the outlet end 6 includes a combustor aft wall 60. The diverging section includes an inner diverging wall 28 and an outer diverging wall 30, collectively defining the radially inner and outer boundaries of the diverging section 48. An annulus 13 is defined between the inner wall 10, the outer wall 8, the inner diverging wall 28, the outer diverging wall 30, and the combustor aft wall 60. The annulus 13 is an annular ring, axisymmetric about a combustor centerline 24. A side view of the annulus 13 is depicted in FIG. 2, however, the annulus 13 extends circumferentially 360 degrees about the combustor centerline 24. The combustor centerline 24 may be colinear and/or overlapping with an engine centerline. An incoming fluid 18 (i.e., air, oxidizer, and/or fuel/air mixture) enters the annulus 13 at a throat area 51 proximate the inlet end 4. The throat area 51 acts as a fluid inlet or air inlet to the combustor annular tube 70. At least one igniter (not shown) may be disposed in the inner wall 10, the outer wall 8, the inner diverging wall 28, and/or the outer diverging wall 30 at the inlet end 4 of the combustor 2, for igniting the fuel/air mixture 18. A combustor exhaust 62 is disposed at an axially downstream end of the annulus 13 proximate the outlet end 6. Combustion gas 19 travels in an axially aft and circumferential direction toward the outlet end 6, where exhaust gas 22 is dispersed through the combustor exhaust 62.

FIG. 2 illustrates an axial direction 68 and a radial direction 66. The axial direction 68 illustrated in FIG. 2 is oriented in an axially aft direction, while the radial direction 66 is oriented in a radially outward direction. An axially forward direction (not shown) is the opposite direction of the axial direction 68 (or axially aft direction) illustrated in FIG. 2. Similarly, a radially inward direction (not shown) is the opposite direction of the radial direction 66 (or radially outward direction) illustrated in FIG. 2. A circumferential or tangential direction is into or out of the plane of the figure (i.e., “into the page”) and is orthogonal to both the radial and axial directions. An air inlet plenum 21 is coupled fluidly upstream of the throat area 51, for delivering air, oxidizer, fluids, and/or fuel-air mixtures to the annulus 13. The air inlet plenum 21 may also be described as a fluid inlet plenum 21 because according to the embodiments described herein, fluids other than air may flow through the fluid/air inlet plenum 21. The air inlet plenum 21 receives a working fluid (air, an oxidizer, and/or fuel-air mixtures) from an axial inlet 50 disposed axially forward of the air inlet plenum 21. The air and/or oxidizer may be pressurized prior to entering the axial inlet 50 via a compressor (not shown), ram effects, and/or via other means.

The air inlet plenum 21 is defined between an inlet portion 34, a first inner reflective surface 42, a first outer reflective surface 44, an inner sidewall 46, an outer sidewall 52, a second inner reflective surface 54, a second outer reflective surface 56, an inner aft wall 58, and an outer aft wall 64. The inlet portion 34 forms a transition between the axial inlet 50 and the air inlet plenum 21. Each of the axial inlet 50 and the air inlet plenum 21 may be axisymmetric about an inlet centerline 32. The first inner and outer reflective surfaces 42, 44 extend radially inward and radially outward, respectively, from the aft end of the inlet portion 34. Each of the first inner and outer reflective surfaces 42, 44 may be contoured. The first inner and outer reflective surfaces 42, 44 are coupled to the inner and outer sidewalls 46, 52, respectively. Each of the inner and outer sidewalls 46, 52 may be linear and extends radially inward and axially aft toward the throat area 51. The radially inward and aft ends of each of the inner and outer sidewalls 46, 52 are coupled to the second inner and outer reflective surfaces 54, 56 respectively.

Referring still to FIG. 2, each of the second inner and outer reflective surfaces 54, 56 may be contoured and extends radially outward and axially aft toward radially outer ends of the inner and outer aft walls 58, 64, respectively. The inner and outer aft walls 58, 64 extend radially inward toward the throat area 51. At the respective radially inward ends, each of the inner and outer aft walls 58, 64 curve radially inward and axially aft, making gradual transitions to the inner and outer diverging walls 28, 30. The inner and outer diverging walls 28, 30 extend either radially outward (i.e., with respect to the outer diverging wall 30) or radially inward (i.e., with respect to the inner diverging wall 28) and extend axially aft toward the inner and outer walls 10, 8 of the annular tube 70. The inner and outer diverging walls 28, 30 are angled radially outward or inward and axially aft at an angle between about 2 degrees and about 60 degrees from the axial direction 68. In other embodiments, the inner and outer diverging walls 28, 30 are angled radially outward or inward and axially aft at an angle between about 3 degrees and about 45 degrees from the axial direction 68. In other embodiments, the inner and outer diverging walls 28, 30 are angled radially outward or inward and axially aft at an angle between about 4 degrees and about 30 degrees from the axial direction 68. In other embodiments, the inner and outer diverging walls 28, 30 are angled radially outward or inward and axially aft at an angle between about 5 degrees and about 20 degrees from the axial direction 68. In other embodiments, the inner and outer diverging walls 28, 30 are angled radially outward or inward and axially aft at an angle between about 6 degrees and about 10 degrees from the axial direction 68.

Still referring to FIG. 2, each of the first inner and outer reflective surfaces 42, 44 may have a curvature that is substantially constant and that is defined by a first radius 72 from the throat area 51. The first radius 72 may extend between each of the first inner and outer reflective surfaces 42, 44, and an intersection of the inlet centerline 32 with an axial location of the minimum flow area at the throat area 51. Each of the second inner and outer reflective surfaces 54, 56 may have a substantially constant curvature that is defined by a second radius 74 from the throat area 51. The second radius 74 may extend between each of the second inner and outer reflective surfaces 54, 56, and an intersection of the inlet centerline 32 with an axial location of the minimum flow area at the throat area 51.

In operation, pressure waves propagate within the annulus area 13 as a result of rotating detonation, and travel primarily circumferentially and toward the aft wall 60. However, portions of pressure waves propagating within the annulus area 13 may also travel back through the throat area 51 toward the axial inlet 50. The portions of the pressure waves that travel back through the throat area 51 may radially, circumferentially, and axially expand within the air inlet plenum 21. Due to the geometry of the air inlet plenum 21, pressure waves that expand therein may reflect off the first inner and outer reflective surfaces 42, 44, as well as the second inner and outer reflective surfaces 54, 56 back toward the throat area 51 (through which they travel back toward the aft wall 60). As a result of portions or one or more pressure waves being reflected from within the air inlet plenum 21 back through the throat area 51 toward the aft wall 60, losses within the combustor 2 associated with propagating pressure and/or detonation waves may be reduced, minimized, and/or eliminated. In some configurations in accordance with the present embodiments, the axial inlet 50 may be angled at least partially in a circumferential and/or radial direction such that pressure waves propagating through the air inlet plenum 21 that travel through the inlet portion 34 may also be reflected off one or more internal walls and/or surfaces of the axial inlet 50 (i.e., in addition to the portions that are reflected off the reflective surfaces 42, 44, 54, 56), back toward the throat area 51.

Still referring to FIG. 2, one or more primary fuel injectors 26 may be disposed in at least one of the inner diverging wall 28 and the outer diverging wall 30, at the throat area 51. The one or more primary fuel injectors 26 may include a fuel nozzle (not shown) that may be aligned substantially radially to disperse fuel within the combustor 2 into oncoming inlet fluid 18 (i.e., inlet air and/or inlet oxidizer). The primary fuel injector 26 disperses fuel via the fuel nozzle into the inlet air 18 (or oxidizer) as inlet air enters the combustor tube 70 at the throat area 51. The primary fuel injector 26 may disperse fuel orthogonal to the direction of the inlet air 18, which may flow into the annulus in an axial direction 68. A fuel plenum 76 may be fluidly coupled upstream of the primary fuel injector 26. The fuel plenum 76 may have a 5-sided cross section as illustrated in FIG. 2, and may also include other suitable cross-sectional shapes such as circular, oval, elliptical, polygonal, trapezoidal, rectangular, square, triangular, hexagonal, as well as other shapes. A first fuel line 38 is fluidly coupled upstream of the fuel plenum 76 for delivering fuel to the fuel plenum 76. A first fuel control valve 40 is fluidly coupled upstream of the first fuel line 38. A fuel supply 36 is fluidly coupled upstream of the first fuel control valve 40. Each of the annular tube 70 (including the inner and outer diverging walls 28, 30 and the throat area 51), the fuel plenum 76, the air inlet plenum 21, and the axial inlet 50 may circumferentially surround the combustor centerline 24 such that each is axisymmetric about the combustor centerline 24.

Referring still to FIG. 2, one or more secondary, tertiary, and/or auxiliary fuel injectors (not shown) may also be disposed within various walls and/or structures of the combustor 2. Each of the inner and outer walls 10, 8 as well as the inner and outer diverging walls 28, 30 may include cooling features disposed therein. In addition, the first inner and outer reflective surfaces 42, 44 as well as the second inner and outer reflective surfaces 54, 56 may include cooling features due to pressure and/or detonation waves reflecting thereupon (which may increase the temperature of each of the reflective surfaces 42, 44, 54, 56). The first and second side walls 46, 52, as well as the inner and outer aft walls 58, 64 may not require active cooling features due to their orientations being at least partially co-planar with (i.e., rather than normal to) an expected propagation vector of pressure and/or detonation waves. However, in other embodiments, the first and second side walls 46, 52 as well as the inner and outer aft walls 58, 64 may also include active cooling features.

Referring still to FIG. 2, the combustor aft wall 60 may be oriented in a radial direction and/or may be oriented to have components in both the radial and axial directions, as illustrated in FIG. 2. For example, the combustor aft wall 60 may be oriented from about 0 to about 30 degrees from a radial direction. In other embodiments, the combustor aft wall 60 may be oriented from about 5 to about 25 degrees from a radial direction. In other embodiments, the combustor aft wall 60 may be oriented from about 10 to about 20 degrees from a radial direction. In other embodiments, the combustor aft wall 60 may be oriented from about 12 to about 18 degrees from a radial direction. The combustor aft wall 60, in concert with the aft end of the inner wall 10, forms the combustor exhaust 62, through which the exhaust flow 22 flows. The combustor exhaust 62 is disposed in a radial gap between the radially inner end of the combustor aft wall 60 and the axially aft end of the inner wall 10. The radial gap extends 360 degrees around the annular combustor 2, axisymmetric or substantially axisymmetric about the combustor centerline 24. The radial gap that defines the combustor exhaust 62 may span a greater linear distance than the radial gap that the defines the throat area 51. Similarly, the flow area of the combustor exhaust 62 may be greater than the flow area of the throat area 51.

The primary fuel injector 26, as well as any other fuel injectors, may disperse fuel through holes and/or orifices that are circular, elliptical, slotted, and/or other suitable shapes. A minimum dimension (i.e., diameter, width, minor axis, etc.) of the holes and/or orifices in each of the primary fuel injector 26 and/or other fuel injectors may be from about 3 to about 30 mils (i.e., thousandths of an inch). In other embodiments, the minimum dimension of the holes and/or orifices may be from about 5 to about 20 mils. In other embodiments, the minimum dimension of the holes and/or orifices may be from about 8 to about 17 mils. In other embodiments, the minimum dimension of the holes and/or orifices may be from about 10 to about 15 mils.

A rotating detonation wave resulting from combustion of a fuel-air mixture from the one or more primary fuel injectors 26 and/or inlet air 18 may travel circumferentially around the combustor 2 as it travels the axial length of the combustor tube (or annular tube) 70, from the inlet end 4 to the outlet end 6. The magnitude of the rotating detonation wave may begin to dissipate as it propagates circumferentially and axially (forward and aft) through the combustor 2. Reflecting pressure and/or detonation waves that travel toward the axial inlet 50 back through the throat area 51 toward the aft end 6 may enhance the performance of the rotating detonation combustor 2, while in operation. As such, the geometry of the air inlet plenum 21, and the reflecting surfaces 42, 44, 54, 56 thereof may allow the combustor 2 to remain in stable operation while simultaneously augmenting the performance of the combustor 2.

In operation, each of the embodiments disclosed herein may include multiple detonation waves simultaneously propagating in a circumferential (and axially aft) direction such that they wrap around the annulus 13 as they move from an inlet end 4 to an outlet end 6. Chemistry and combustor dynamics, as well as other factors, may limit the minimum size of both the combustor 2 as well as the area and/or volume of the annulus 13 due to a minimum amount of time required for the rotating denotation wave to travel around the annulus. As such, the area of the annulus 13, the overall radius of the combustor 2, and/or the overall axial length of the combustor 2 may all be adjusted to ensure the chemistry considerations as well as other factors such as combustor dynamics, aerodynamics, thermal management, and other considerations are all balanced accordingly. In addition, it may be desirable for the combustor 2 to have a non-circular shape in order to increase the distance around the annulus 13 that the rotating detonation wave may travel, while simultaneously allowing the axial length of the combustor 2 to be decreased.

As used herein, “detonation” and “quasi-detonation” may be used interchangeably. Typical embodiments of detonation chambers include a means of igniting a fuel/oxidizer mixture, for example a fuel/air mixture, and a confining chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, autoignition or by another detonation via cross-firing. The geometry of the detonation chamber is such that the pressure rise of the detonation wave expels combustion products out of the detonation chamber exhaust to produce a thrust force, as well as for other purposes such as flow control actuation. In addition, rotating detonation combustors are designed such that a substantially continuous detonation wave is produced and discharged therefrom. Detonation may be accomplished in a number of types of detonation chambers, including detonation tubes, shock tubes, resonating detonation cavities, and annular detonation chambers.

Each of the embodiments disclosed herein include fuel being combusted in the presence of an oxidizer. Fuel mixes with an oxidizer during or prior to the combustion process. The embodiments disclosed herein include air as one possible oxidizer. However, other oxidizers such as straight oxygen (i.e., pure oxygen) are also possible. In various conditions, oxygen may be a preferred oxidizer over air. In other conditions, air may be the preferred oxidizer. As used herein, the terms “oxygen” and “pure oxygen,” may include gas that is at least about 80% oxygen by mass. In some embodiments, the oxidizer may be at least about 90% oxygen by mass. In other embodiments, the oxidizer may be about 93% to about 99.3% oxygen by mass. In other embodiments, the oxidizer may be greater than about 99.3% oxygen by mass. (By comparison, air is about 21% oxygen, about 78% nitrogen and about 1% other gases). Other oxidizers other than oxygen and air are also possible. In embodiments that use an oxidizer other than air, those embodiments will include the corresponding system components including, for example, an oxidizer inlet, an oxidizer supply line, an oxidizer supply, an oxidizer flow control mechanism, an oxidizer flow modulator, and/or a second oxidizer inlet.

Each of the embodiments disclosed herein include a source of ignition, which may be in the form of a spark igniter and/or via autoignition (i.e., via heated inner and outer walls 10, 8, and/or heated inner and outer diverging walls 28, 30 which have absorbed heat from the combustion process), as well as via volumetric ignition. Some embodiments may include multiple sources of ignition. For example, in some embodiments, at least one spark igniter may be used during some operating conditions and then ignition may transition to autoignition and/or volumetric ignition at other operating conditions.

The present embodiments include an aircraft, an engine, a combustor, and/or systems thereof which include rotating detonation combustion. The embodiments presented herein operate on a kilohertz range (1000 Hz to 1000 kHz), which is faster than the 100 Hz operating frequency of previous pulse detonation actuators (PDA) and/or pulse detonation engines (PDE). As such, the embodiments presented herein may provide a more continuous and less pulsed combustion gas jet discharging from the combustor exhaust 62 compared to previous pulse detonation actuators (PDA).

The present embodiments offer both high operating frequency and significant control authority, which provides benefits in numerous practical applications, such as engine exhaust thrust vectoring for vehicle control or boundary layer separation control for aircraft lift enhancement and drag reduction. The present embodiments may also be used as enhancements or combustion systems for supersonic and/or hypersonic applications, for example, in scramjet engines, as well as in subsonic gas turbine applications. The present embodiments take advantage of a more compact and/or power dense combustion system. The present embodiments may be used as the primary combustion system for engines such as gas turbine engines. The present embodiments may be used as the secondary, tertiary, and/or auxiliary combustion systems for engines such as gas turbine engines, and/or other components of an aircraft or of other applications.

Exemplary applications of the present embodiments may include high-speed aircraft, separation control on airfoils, flame holders, flame stability, augmenters, propulsion, flight stability, flight control, as well as other uses.

Although specific features of various embodiments of the present disclosure may be shown in some drawings and not in others, this is for convenience only. In accordance with the principles of the present disclosure, any feature of a drawing may be referenced and/or claimed in combination with any feature of any other drawing.

This written description uses examples to disclose the embodiments of the present disclosure, including the best mode, and also to enable any person skilled in the art to practice the disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A combustion system comprising:
an annular tube disposed between an inner wall and an outer wall, the annular tube extending from an inlet end to an outlet end;
at least one fluid inlet disposed in the annular tube proximate the inlet end, the at least one fluid inlet providing a conduit through which fluid flows into the annular tube;
at least one outlet disposed in the annular tube proximate the outlet end; and
at least one inlet fluid plenum disposed upstream of the at least one fluid inlet,
wherein the at least one inlet fluid plenum comprises at least one reflective surface.

2. The combustion system of claim 1, wherein at least one rotating detonation wave propagates through the annular tube.

3. The combustion system of claim 2, wherein a portion of the at least one rotating detonation wave reflects off the at least one reflective surface through the at least one fluid inlet.

4. The combustion system of claim 1, the at least one reflective surface further comprising a first inner reflective surface and a first outer reflective surface, the first inner reflective surface disposed radially inward of the first outer reflective surface.

5. The combustion system of claim 4, wherein each of the first inner and outer reflective surfaces comprise at least one first contoured portion, and
wherein the at least one first contoured portion is defined by a first radial distance from a radial center at the at least one fluid inlet.

6. The combustion system of claim 5, the at least one reflective surface further comprising a second inner reflective surface and a second outer reflective surface, the second inner reflective surface disposed radially inward of the second outer reflective surface.

7. The combustion system of claim 6, wherein each of the second inner and outer reflective surfaces comprise at least one second contoured portion, and
wherein the at least one second contoured portion is defined by a second radial distance from the radial center at the at least one fluid inlet.

8. The combustion system of claim 7, wherein the first radial distance is greater than the second radial distance.

9. The combustion system of claim 1, wherein the at least one reflective surface is axially forward of the at least one fluid inlet.

10. The combustion system of claim 1, wherein the at least one reflective surface is upstream of the at least one fluid inlet.

11. The combustion system of claim 1, wherein the at least one fluid inlet comprises a throat area.

12. The combustion system of claim 11, further comprising at least one fuel injector disposed at the at least one fluid inlet, the at least one fuel injector dispersing fuel into the throat area.

13. The combustion system of claim 11, further comprising at least one fuel plenum disposed upstream of the at least one fuel injector.

14. The combustion system of claim 8, further comprising:
at least one throat area at the at least one inlet;
at least one fuel injector disposed at the at least one fluid inlet, the at least one fuel injector dispersing fuel into the throat area; and
at least one fuel plenum disposed upstream of the at least one fuel injector,
wherein at least one rotating detonation wave propagates through the annular tube,
wherein a portion of the at least one rotating detonation wave reflects off the at least one reflective surface through the at least one fluid inlet, and
wherein the at least one reflective surface is axially forward of the at least one fluid inlet.

15. A combustion system comprising:
an annular tube disposed between an inner wall and an outer wall;
a diverging section disposed axially forward of the annular tube, the diverging section comprising an inner diverging wall and an outer diverging wall;
at least one throat area disposed axially forward of the diverging section; and
a fluid inlet plenum disposed axially forward of the at least one throat area, the fluid inlet plenum comprising at least one reflective surface.

16. The combustion system of claim 15, wherein at least one rotating detonation wave travels from the at least one reflective surface to the annular tube via the at least one throat area.

17. The combustion system of claim 15, wherein each of the inner and outer diverging walls is oriented between about 2 degrees and about 60 degrees from an axial direction.

18. A combustion system comprising:
an annular tube disposed between an inner wall and an outer wall;
at least one throat area disposed axially forward of the annular tube; and
a fluid inlet plenum disposed axially forward of the at least one throat area, the fluid inlet plenum comprising at least one reflective surface,
wherein at least one rotating detonation wave travels from the at least one reflective surface through the at least one throat area.

19. The combustion system of claim 18, the at least one reflective surface further comprising more than one reflective surface.

20. The combustion system of claim 19, the at least one reflective surface further comprising:
at least one first reflective surface disposed at a first radial distance from the at least one throat area; and
at least one second reflective surface disposed at a second radial distance from the at least one throat area.
